(19) United States
(12) Patent Application Publication
(10) Pub. No.: US 2014/0207431 A1
(43) Pub. Date: Jul. 24, 2014

(54) URBAN MAPPING TECHNIQUE FOR PHOTOVOLTAIC POTENTIAL OF ROOFTOPS

(71) Applicant: Massachusetts Institute of Technology, Cambridge, MA (US)

(72) Inventors: Christoph F. Reinhart, Cambridge, MA (US); John Alstan Jakubiec, Cambridge, MA (US)

(73) Assignee: Massachusetts Institute of Technology, Cambridge, MA (US)

(21) Appl. No.: 14/160,658

(22) Filed: Jan. 22, 2014

Related U.S. Application Data
(60) Provisional application No. 61/755,600, filed on Jan. 23, 2013.

(51) Int. Cl. G06F 17/50

(52) U.S. Cl. CPC G06F 17/5009
USPC 703/2

(57) ABSTRACT

A photovoltaic map generator is provided that includes a data generator that provides LiDAR data illustrating detailed information of a geographic area. A model generator receives the LiDAR data and uniformly resamples the LiDAR data over a plan grid of specified spacing to produce simplified LiDAR data. The data points of the simplified LiDAR data are triangulated using a Delaunay algorithm to produce a highly accurate and detailed 3-D model of the geographic area.

### SPONSORSHIP INFORMATION

This invention was made with government support under Grant No. EFRI-1038264 awarded by the National Science Foundation. The government has certain rights in the invention.

### PRIORITY INFORMATION

This application claims priority from provisional application Ser. No. 61/755,600 filed Jan. 23, 2013, which is incorporated herein by reference in its entirety.

### BACKGROUND OF THE INVENTION

The invention is related to the field of map generation, and in particular to an urban mapping technique for photovoltaic potential of rooftops.

It has become increasingly popular for cities and municipalities to create solar potential maps with the intent of promoting renewable energy generation through photovoltaic (PV) panel installations within those jurisdictions. In the United States, large cities such as Boston, Los Angeles, New York City and Portland provide online maps which allow building owners to look up their address and view personalized predictions of: (1) electric production from a PV system (kWh); (2) energy savings from a SHW system (Therms); (3) resulting annual electricity savings (dollars); (4) carbon savings (lbs); (5) useful roof area for installing PV panels (sq. ft.); (6) system payback period (years); (7) system costs (dollars); local rebates and incentive programs (dollars savings).

The objective of these maps and accompanying personalized property information is to increase the environmental awareness of residents, reduce greenhouse gas emissions and to improve the sustainable image of a city through the expansion of solar energy technology. While a number of cities have already generated such solar maps, to the authors' knowledge, limited attention has been paid to the assumptions and calculation methods underlying these maps.

The use of a constant, global horizontal solar radiation value across a rooftop is commonly used and in many cases is inaccurate, for example buildings with peaked roofs. Such a constant value also does not consider local urban context such as trees and neighboring buildings which shade building rooftops. Furthermore, the complex forms of individual roofs are ignored. Advocates of this approach determine the useful roof area for PV installation by using either a constant percentage (Boston, Portland) or based on orthophotographic image analysis techniques (San Francisco, Berkeley). The NREL PVWatts module is a more detailed method in which solar irradiation is distributed on a 40 km square grid for the entire United States based on the typical meteorological year 2 (TMY), dataset. Local TMY2 irradiation data is used in combination with PV panel tilt, orientation, and urban temperature conditions to determine energy production. While roof shape is treated with greater detail than in a solar constant approach, shading and reflections from adjacent urban surfaces also cannot be modeled using PVWatts.

Esri's Solar Analyst plugin currently constitutes the most widely used irradiation calculation method in urban PV potential mapping. In this method, a sky mask is initially generated based on the surroundings of each pixel of a digital elevation model (DEM). A DEM is a geolocated raster image where the values of individual pixels correspond to elevation measurements. The direct and diffuse components of irradiation are calculated based on the amount of the sky which can be seen from each pixel. Direct irradiation is calculated in accordance with the sun position, the slope of the DEM, a fixed transmissivity coefficient, and the distance a solar ray must travel through the atmosphere. Diffuse irradiation is calculated in much the same way as the direct component, based on either a uniform sky model or a standard overcast model; however, no solar map reports on its website which sky model was used.

In Solar Analyst, sky transmissivity and the ratio between direct and diffuse insolation are fixed, constant values throughout the year. These assumptions can have a significant effect on the calculated annual radiation. For example, the Boston Logan TMY3 weather data illustrates a ratio between direct and diffuse irradiation which varies widely throughout the year. FIG. 1 shows diffuse horizontal irradiation versus direct horizontal irradiation for all sunlit hours of the year for the Boston climate TMY3 dataset. Points are shaded based on the observed cloud cover at that hour. The mean direct-to-total ratio of insolation for Boston is 64%; however, the standard deviation from the mean is 31%, and neglecting this variance is obviously incorrect. One can imagine a site with predominantly clear skies in the morning and cloudy afternoons. For that site an Eastwards titled surface receives considerably more solar radiation than its West facing counterpart, a climate-specific idiosyncrasy that the Esri model cannot resolve.

As Solar Analyst uses only a sky mask based on a DEM, it has no capacity to model reflections between buildings, from surrounding trees or from the urban terrain. It has been proposed to assume a directional constant of reflected irradiation for obscured sky areas, but it would be inadequate to consider complex reflections from surrounding buildings.

### SUMMARY OF THE INVENTION

According to one aspect of the invention, there is provided a photovoltaic map generator. The photovoltaic map generator includes a data generator that provides LiDAR data illustrating detailed information of a geographic area. A model generator receives the LiDAR data and uniformly resamples the LiDAR data over a plan grid of specified spacing to produce simplified LiDAR data. The data points of the simplified LiDAR data are triangulated using a Delaunay algorithm to produce a highly accurate and detailed 3-D model of the geographic area.

According to another aspect of the invention, there is provided a method of generating a photovoltaic map. The method includes providing LiDAR based data illustrating detailed information of a geographic area. Also, the method includes receiving the LiDAR data and uniformly resampling the LiDAR data over a plan grid of specified spacing to produce simplified LiDAR data using a model generator. Moreover, the method includes triangulating the data points of the simplified LiDAR data using a Delaunay algorithm to produce a highly accurate and detailed 3-D model of the geographic area.

### BRIEF DESCRIPTION OF THE DRAWINGS

FIG. 1 is a graph illustrating hourly direct and diffuse radiation and cloud cover from Boston Logan TMY3 weather data;

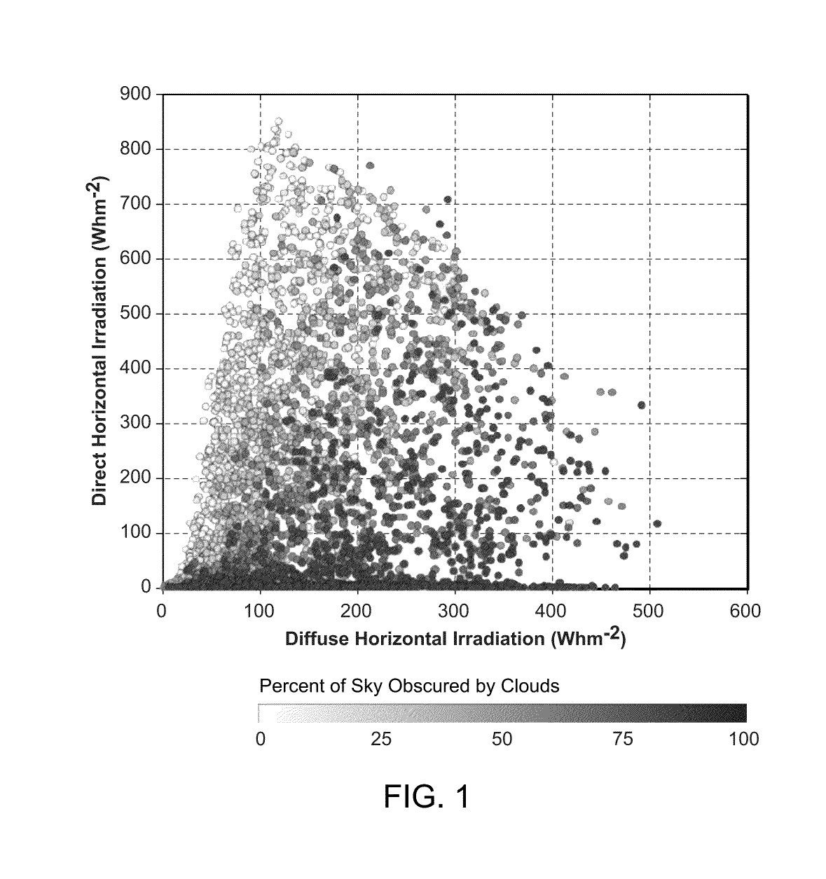

FIG. 2 is a schematic diagram illustrating a 3D urban model formed in accordance with the invention;

FIGS. 3A-3D are process images illustrating 3-D model generation from LiDAR and GIS Data;

FIG. 4 is a table illustrating key Radiance/DAYSIM simulation parameters;

FIG. 5 is a table illustrating system parameters of selected PV system;

FIGS. 6A-6B are images illustrating detailed building simulation models in urban context;

FIGS. 7A-7C are graphs illustrating hourly results of simulations used in accordance with the invention;

FIGS. 8A-8B are graphs illustrating measured vs simulated daily PV energy production;

FIGS. 9A-9B are graphs illustrating monthly comparison of typical energy prediction methods;

FIG. 10 is a table illustrating typical annual results and percent errors compared to detailed DAYSIM method;

FIG. 11 is a schematic diagram illustrating ten test buildings used in comparing results used in accordance with the invention;

FIG. 12 is table illustrating predicted irradiation MBE and RMSE results compared to DAYSIM-based calculations;

FIG. 13 is a schematic diagram illustrating resulting Point Irradiation Maps For Varying Calculation Methods

FIG. 14 is a table illustrating the annual PV production, roof area and costs as determined by model assumptions;

FIGS. 15A-15B are annual irradiation maps (cumulative sky method) for varying degrees of geometric accuracy; and

FIG. 16 is a schematic diagram illustrating public rooftop photovoltaic potential map of Cambridge.

### DETAILED DESCRIPTION OF THE INVENTION

The invention demonstrates and validates a method for predicting city-wide electricity gains from photovoltaic panels based on detailed geometric urban massing models combined with DAYSIM-based hourly irradiation simulations, typical meteorological year climactic data and calculated rooftop temperatures. The resulting data can be combined with Google Maps™ type online search engines and a financial module that provides building owners interested in installing a photovoltaic system on their rooftop with meaningful data regarding spatial placement, system size, installation costs and financial payback.

Overall the method constitutes a first attempt at linking increasingly available GIS and LiDAR based urban databases with state-of-the-art building performance simulation engines. A comparison of irradiation simulations and geometry generation methods reveals that the new methodology outperforms its predecessors as it produces hourly data, supports better geometric accuracy, considers reflectances of solar radiation from neighboring buildings and uses predicted rooftop temperatures to calculate hourly PV efficiency. A validation study of measured and simulated electricity yields from two rooftop PV installations in Cambridge shows that the new method is able to predict annual electricity gains within 3.6 to 5.3% of measured production when calibrating for measured weather data. Predicted annual error using the new method is less than the variance which can be expected from climactic variation between years.

A comparison of predicted monthly electricity generation between the new method and previous urban photovoltaic prediction methods yielded monthly mean bias errors and root mean square errors between −200.5 and 91.6 kWh and 124.3 and 269.4 kWh respectively, revealing that the new method is significantly more accurate than former methods. Irradiation and predicted spatial economic feasibility are compared at an urban-scale for ten sample buildings in the city of Cambridge. Furthermore, because the new method generates hourly data, it can be applied to peak load mitigation studies at the urban level.

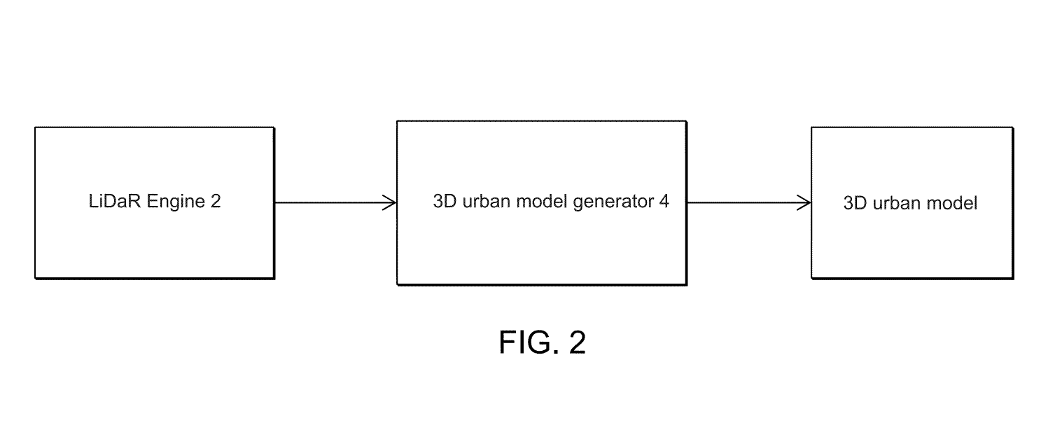

The invention is based on the creation of a detailed 3-D model in the validated Radiance/DAYSIM backward-ray tracing daylight simulation engine. The geometric information used in creating the detailed digital model of Cambridge comes from a publicly-funded 2010 LiDAR measurement. LiDAR, Light Detection And Ranging, is an established, accurate measurement system wherein a surveying aircraft emits rapid laser bursts and records the time until their visual return while tracking its location via Global Positioning Systems (GPS). The collected location and timed return data is later processed into geographically located point data. The vertical accuracy of the data in the urban context of Cambridge was bounded to less than 1 m root mean squared error (RMSE), and in validation tests of selected areas the RMSE between LiDAR and traditional GPS measurement methods was shown to be 0.062 m. Moreover, the LiDAR measurements provide the LiDAR data to the inventive 3-D urban model engine that generates the inventive 3-D urban model, as shown in FIG. 2.

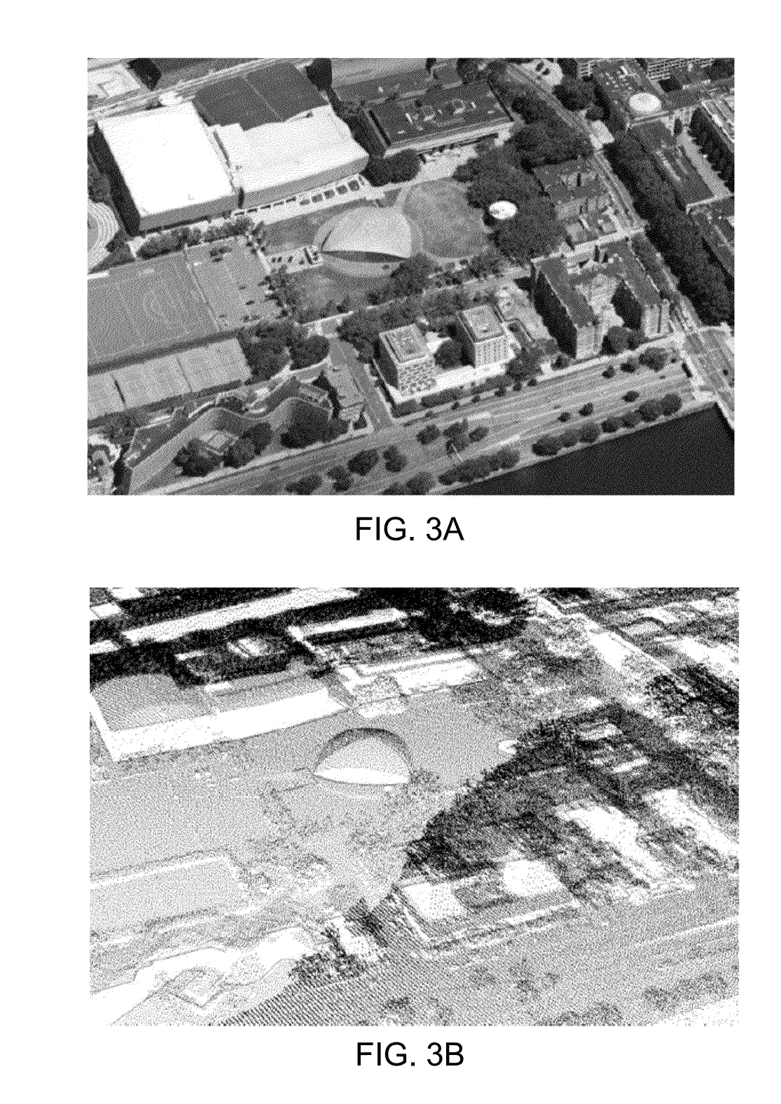

The process of creating a detailed 3-D urban model is illustrated with an example surrounding the Kresge Oval at the Massachusetts Institute of Technology, as shown in FIG. 3A. As LiDAR data is not uniformly sampled in plan, it creates an awkward data space, as shown in FIG. 3B, where different point densities are present depending on the airplane path of flight. Initially, there were 126,624,764 points spread across Cambridge which has a total area of approximately 4,500 acres (18.5 km2). One can uniformly resample the LiDAR data over a plan grid of approximately 1×1 m spacing, taking the maximum value of the first return data where multiple points exist. This results in a simplification of the data space to a mere fraction of the initial point density without losing much geometric accuracy. The simplified LiDAR-derived points are then divided into two categories using publicly available building polyline GIS datasets: buildings and ground scape. The resampled points are triangulated using a Delaunay algorithm, and appropriate Radiance material models are applied to buildings and ground objects. This results in a highly accurate and detailed 3-D model of the entire city. This complete 3-D model is divided into 1450×1450 m quadrants for simulation. Each quadrant consists of 750×750 m of virtual rooftop to be simulated surrounded by 350 m of context in each direction. By dividing the city into representational sections, simulation time and memory overhead is greatly reduced.

The simplified LiDAR-derived points were then divided into two categories using publicly available GIS datasets from the City of Cambridge: buildings and ground scape, as shown in FIG. 3C. As a last step the two point groups were triangulated using a Delaunay algorithm shown in FIG. 3D, resulting in a highly accurate and detailed 3-D model of the entire City of Cambridge that consists of 16,547,790 triangular surfaces.

The triangulated surface model was then converted into the Radiance backward raytracer format. In Radiance each surface may have different, highly customized, optical surface properties. It is assumed that building walls are Lambertian diffusers with a 35% reflectance while building roofs and ground have a diffuse reflectance of 20%. Annual irradiation was then calculated on each building roof surface at a grid resolution of 5′×5′ (1.5×1.5 m). Simulation sensor points are located approximately 1/64″ (0.4 mm) above and facing in the normal direction of the roof surface.

Simulations are performed with DAYSIM, a validated Radiance plug-in which uses a daylight coefficient approach and the Perez all weather sky model to predict annual point illumination and irradiation while considering climate-specific data. DAYSIM works by performing one raytrace operation to a sky dome consisting of 145 diffuse sky segments, 3 ground segments and a second raytracing run with approximately 65 direct solar positions that are distributed along the annual solar path. By tracing backwards from the simulation sensor points, each sky segment is then weighted relative to its contributions to each point in the scene. In this manner, irradiation can be simulated across an entire year in any incremental time step without running thousands of separate and lengthy raytracing calculations.

In order to ensure accuracy, the Radiance/DAYSIM simulation parameters were considered in relation to the unusually large size of the Cambridge model. Errors in the ambient calculation were calibrated to be acceptable for surfaces spaced four feet apart and larger. As the model was resampled at this resolution in plan and simulation sensor points are spaced beyond this threshold, the assumption seems reasonable. According to

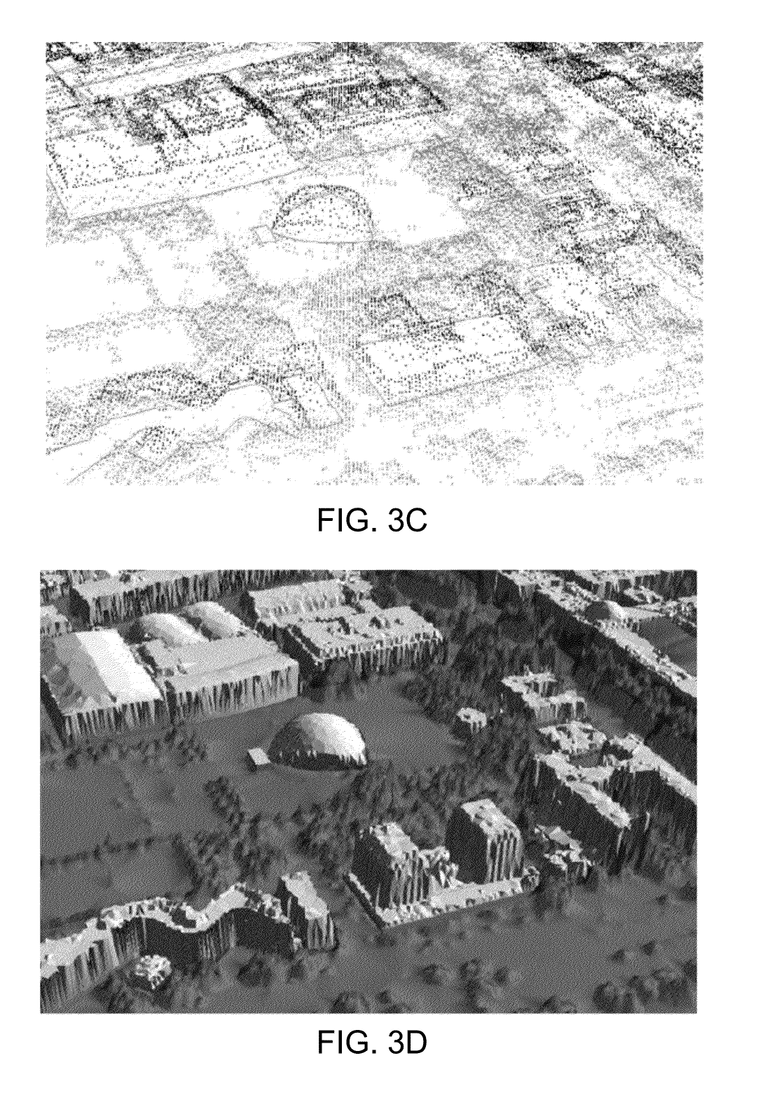

Ward, error will increase on surfaces spaced closed than the scene size divided by the ambient resolution. Thus the Radiance scene size of 26,526.5 ft divided by four gives an ambient resolution of approximately 6,750. FIG. 4 documents the DAYSIM simulation parameters used.

As previously discussed, a key benefit of this method is direct access to hourly simulated irradiation data and the detailed Perez sky model that mimics actual sky radiance distributions for each hourly time step in the year. Knowing in addition the explicit area beneath each simulated point and information about the urban climate, a reasonable approximation can be made for the performance of a PV panel in an urban context.

A direction vector is assigned to each simulation point based on the normal direction of the roof surface immediately below it. Assuming that the roof is planar and unvarying below the area the point represents, ˜25 ft2 in this case, a method of calculating the area is shown in Equation 1,

$${A}_{proj} = \frac{{A}_{flat}}{[ 0 \; 0 \; 1 ] \cdot {n}^{->}} \qquad ( 1 )$$

where \vec{n}is the unitized roof surface normal vector.

One can furthe r realize that photovoltaic performance is dependent on many factors which are unknown at the time of making a conceptual irradiation map such as module efficiency, panel orientation, wiring and equipment and maintenance. However, it is known that high ambient temperature and solar radiation heating up the panel will have an adverse effect on its production. Further, air temperatures near urban rooftops will be higher than the ambient air temperature due to the effects of solar radiation; therefore, the sol-air temperature is used to approximate this phenomenon, shown in Equation 2. The sol-air temperature is the urban ambient temperature (T_{amb-air},) plus the absorptivity of the roof (∝, percent) multiplied by the incident irradiation (E, Wm⁻²) and divided by a convective and radiative loss factor (hₑ, Wm⁻²-K) which one can assume to be a constant 15 Wm⁻²-K. The sol-air temperature is used to predict panel temperatures in Equation 3 by relying upon knowledge of the nominal operating cell temperature at ideal conditions (T₀). Further, the photovoltaic maximum power at ideal conditions (Pₘₚ₀, W) can be derated based on a temperature correction factor (γ, %/K) (Equation 4). The temperature correction factor is usually provided by the PV panel manufacturers with panel specification information.

$$\begin{matrix}{T}_{sol \text{-} air} = {T}_{amb \text{-} air} + \frac{( ∝ * E )}{{h}_{c}} & ( 2 ) \\ {T}_{c} = {T}_{sol \text{-} air} + \frac{( {T}_{0} - 20 ° C . ) * E}{1000 {Wm}^{- 2}} & ( 3 ) \\ {P}_{m p} = {P}_{m p 0} * [ 1 + γ * ( {T}_{C} - {T}_{0} ) ] & ( 4 )\end{matrix}$$

The equations above are used as a first-order approximation in derating panel efficiency based on ambient air temperature and point irradiation at each hourly timestep.

Useful rooftop area in the model is calculated based on the predicted economic feasibility of panels installed at a location. Any roof surface sloping greater than 60 degrees (67%) was discarded and instead considered to be a vertical surface or wall. The reader should note that this cutoff was an arbitrary choice and the method itself would also be capable of modelling façade integrated photovoltaics.

According to the Massachusetts Clean Energy Center, in 2011 the average PV installation costs were $5.67 per watt in Cambridge (MassCEC, 2012). Assuming a typical panel that is rated at 17.2 W/ft2 (185 W/m²), the installation cost follows to be $97.52/ft² ($1049.70/m²). The 2012 Cambridge cost of electricity for residential customers was $0.15/kWh. Requiring a 10 year investment period with a 10% discount rate per year, 115.7 kWh/ft²-yr (1244.9 kWh/m²-yr) would have to be generated to have a net present value (NPV) in which the investment breaks even, when NPV equals zero. An ideally oriented solar panel in Cambridge receives around 149 kWh/ft²-yr (1,600 kWh/m²-yr) annually and would hence require a panel efficiency of close to 80% in Cambridge for the system to break even in ten years according to NPV. If one only required a simple payback over the same 10 year period, the panel efficiency would still have to be nearly 50%.

National and state rebate programs that exist to improve the economic feasibility of PV for residential properties seriously change the financial outlook of such installations. In 2012 the US federal government offered a 30% tax rebate on the cost of a PV installation up to a maximum of $2,000 (Energy Improvement and Extension Act 2008). Further, Massachusetts offered a 15% rebate up to a maximum of $1,000 that could be carried over for three years (Residential Renewable Energy Income Tax Credit 1979). The Massachusetts Clean Energy Center offered a minimum $0.40/W rebate on new PV systems (MassCEC 2012). Massachusetts offered a 100% protection from increased property taxes due to PV installations for a 20 year period (Renewable Energy Property Tax Exemption 1975). Finally, Solar Renewable Energy Certificates (SRECs) are ways of trading proof of generating sustainable energy as a commodity.

The ‘floor’ price of these commodities is currently valued at 0.285 USD/kWh (DSIRESOLAR 2012). Factoring these rebates and incentives into the previous NPV calculation, it is possible to have a break even point for an unshaded panel at 7.5% efficiency without accounting for future energy prices or PV panel degredation. This means that considering an investment period of 10 years for an example Sunpower panel, any point which has the capacity to generate over 11.25 kWh/ft² (121 kWh/m²) of energy per year is likely to recoup its value while providing additional savings after the initial 10 year period as the effective lifetime of a PV system is known to be typically greater than 30 years. Thus such points and their associated roof areas are considered to be useful to install PV panels. As such sensor points are displayed spatially (see results section), it is possible to determine optimal placement locations for PV panels coincident with urban rooftops.

All GIS models including the LiDAR data and building footprints were constructed in the projected North American Datum 1983. This is a serendipitous choice as distances and areas can still be measured without necessitating corrections. Thus, the Radiance simulation model was built in an identical coordinate system. The Massachusetts State Plane system also has a known relationship between X and Y coordinates and latitude and longitude global coordinates. It is possible to translate easily between the two coordinate systems by use of an Inverse Lambert Conformal Conic Projection with proper parameters.

The invention was validated against measured energy production from two installed photovoltaic systems in Cambridge. One system is located on the MIT campus' student center building, and the other is a private residence. For each system, hourly measured energy production is compared to hourly predicted energy production. The reader should note that this hourly comparison could is only conducted with the new method since previous methods cannot predict hourly electricity yields

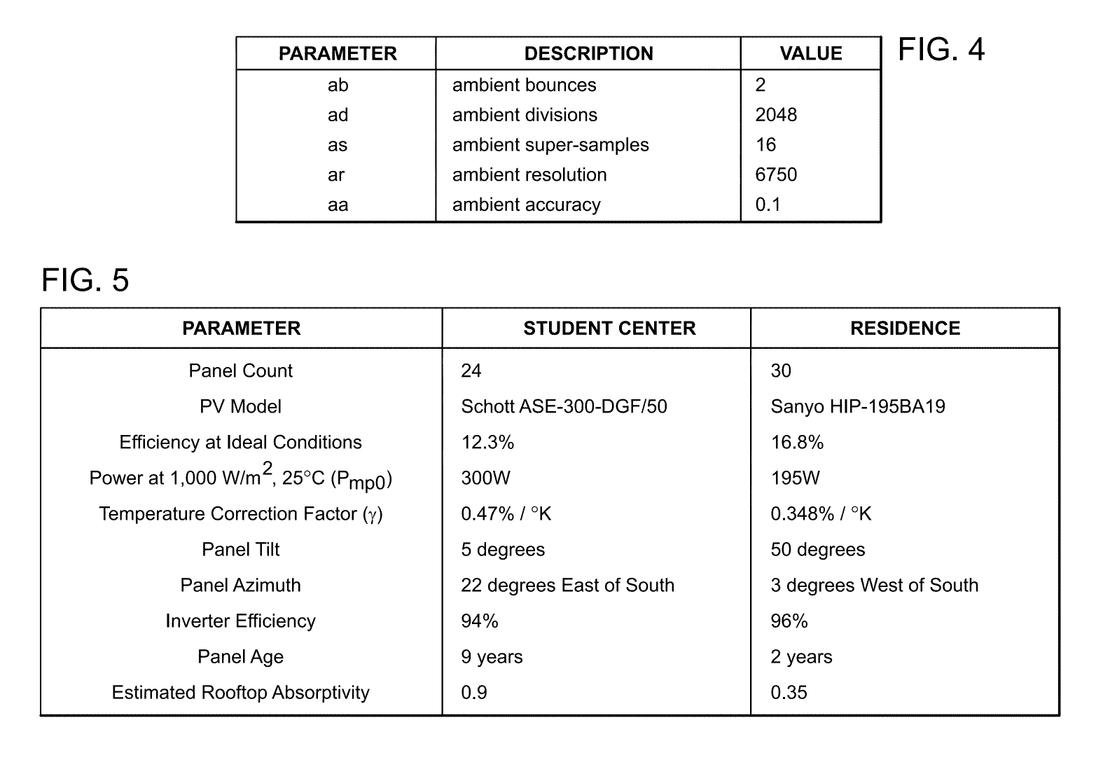

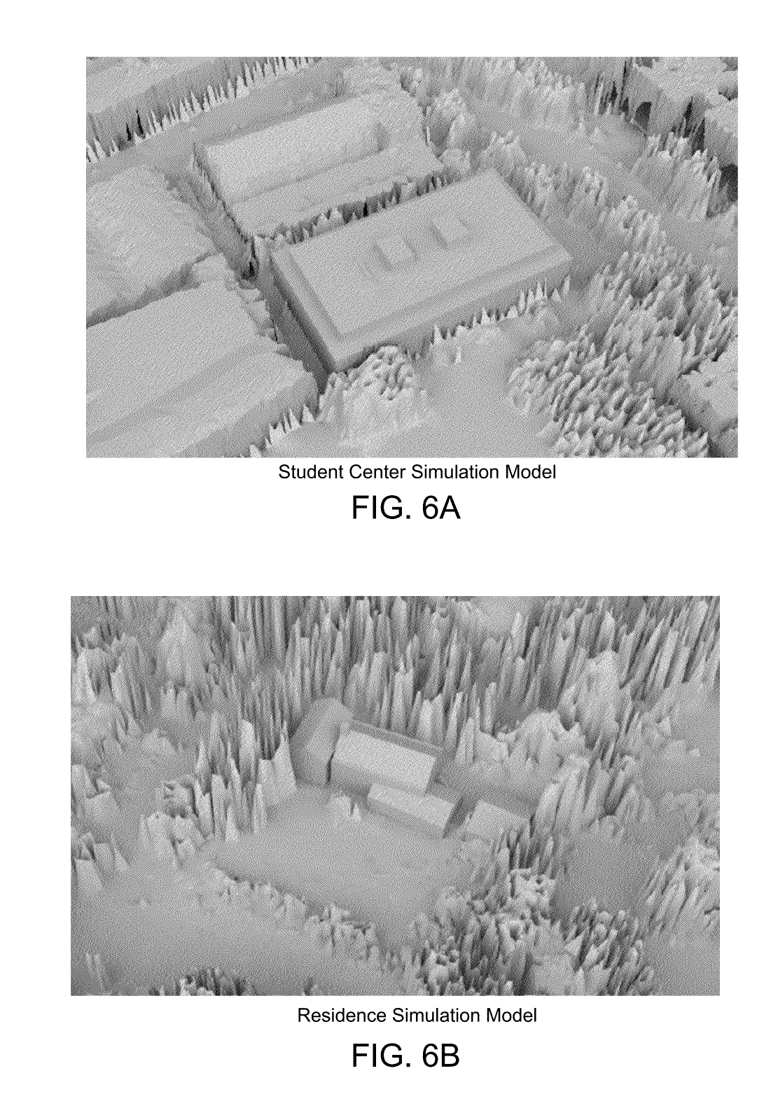

The first of the two systems is a 7.2 kW system installed on the roof of the student center, and the second is a 5.9 kW system in a dense residential area of Cambridge. The student center system consists of 24 Schott 300W panels that were installed approximately nine years ago. The residential system consists of 30 Sanyo 195W panels that are two years old. Detailed information for both systems is contained in FIG. 5 below. FIGS. 6A-6B shows the simulation models used in the validation. Both of the models include the detailed surrounding urban context and accurate representations of the photovoltaic panels being compared to.

The student center system is installed nearly flat with a panel tilt of 5 degrees while the residential system is installed on a peaked roof which has a tilt of 50 degrees. The student center system is primarily unshaded by its context; however, trees and a chimney shade portions of the residential system during some times of the year. Furthermore, the student center system has a black asphalt roof while its residential counterpart has a very light colored roof. Because the two models are very different in terms of orientation, context, geometry and roof color, one can suggest that they constitute a reasonable sample of common urban conditions against which to test the new method.

In order to compare measured PV energy yields to simulated predictions, it was necessary to use weather data from the period of measurement. For this purpose, global horizontal solar irradiation and measured ambient air temperature readings at 15 minute intervals were acquired from a weather station approximately 0.6 miles (1 km) away from the MIT campus for the period of July 2011-June 2012.

These were averaged into hourly values, and global horizontal solar irradiation was converted into direct and diffuse components. Further, the known information in Table 5 regarding the two PV panel systems was employed in calculating the resulting energy production using the same procedure as explained earlier. Panel efficiency was further reduced by a factor of 0.5% per year of operation. For example, the nine year old student center PV system is reduced by a factor of 4.5% as it is nine years old such that the calculation results in a reduced efficiency of 11.75%. Detailed geometric models of the panel systems were digitally constructed as the sizes of individual panels are smaller than the original 3-D model could accommodate with accuracy.

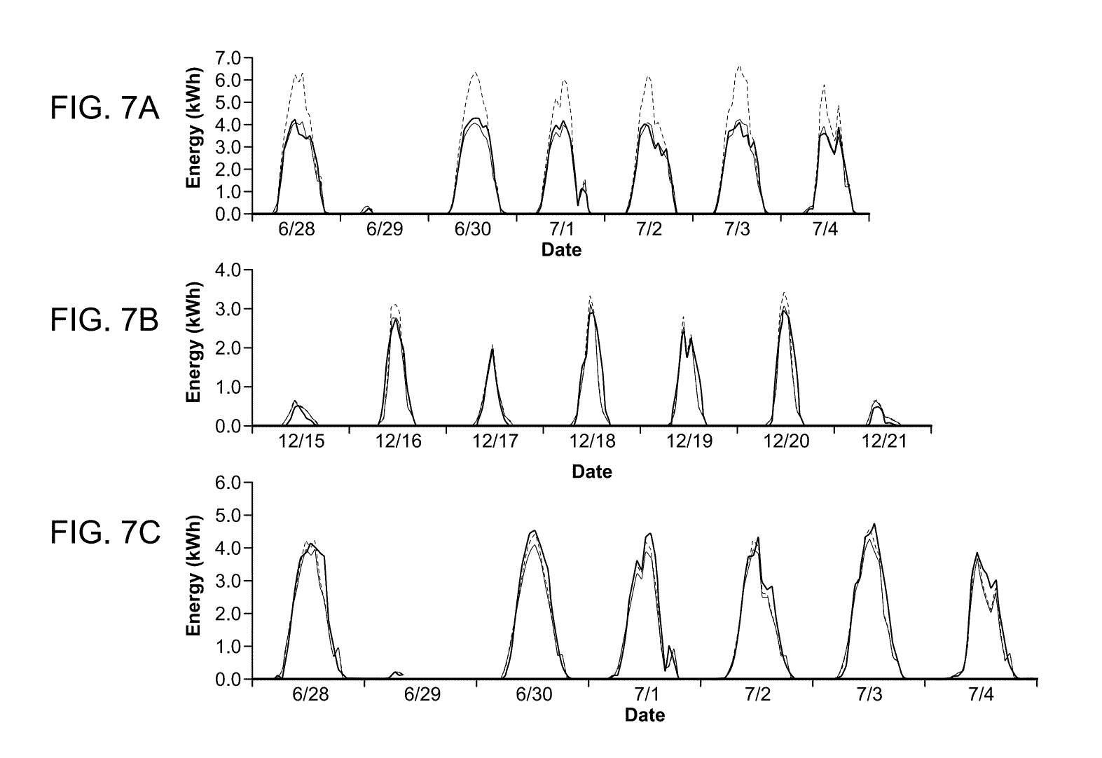

FIGS. 7A-7C illustrates typical summer and winter weeks of hourly measured and simulated data for both analyzed PV installations. The residential system does not have winter week data as there was systematic missing and shifted data for that portion of the year. The solid black lines represent measured energy generation while the red lines indicate predicted energy generation by the model using the predicted sol-air temperature; the black dotted lines show predicted energy generation using the ambient urban air temperature. FIGS. 7A and 7B show results for the student center system. FIG. 7A illustrates a summer week in 2012, and measured and predicted energy values are very similar with a RMSE of 0.32 kWh during daylit hours or 4.4% of the rated capacity of the system. FIG. 7B shows similar results during the 2011 winter with a RMSE of 0.34 kWh during sunlit hours or 4.7% of the system capacity. FIG. 7C illustrates a typical summer week of the residential PV system. Its RMSE is 0.43 kWh or 7.3% of the rated system capacity.

An interesting observation is that the effect of high rooftop temperatures is very strong during hot Summer days in Cambridge, especially for the unshaded student center system located on the dark roof with an estimated absorptivity of 0.9. FIG. 7A shows that the predicted energy using ambient temperature varies from the measured and predicted energy values for the student center by on average 18.3% during the summer week. The maximum deviation during this same time is 36.7% on 7/3. FIG. 7C showing the residential system displays a lesser effect because the Sanyo panels are less sensitive to changes in temperature and the rooftop of the residential system is clad in a lighter colored material, with an estimated absorptivity of 0.35. During the winter, the ambient temperature is cold enough that it is a rare occurrence where the predicted energy using ambient air temperature and sol-air temperature vary; however, on 12/16 and 12/20 shown in FIG. 7B, there are peak periods where there is an observable reduction in predicted energy generation due to higher PV panel temperatures. These observations suggest that the consideration of urban rooftop temperatures is important to understanding photovoltaic yields, especially in climates that are warm for a portion of the year and for buildings with dark roof surfaces.

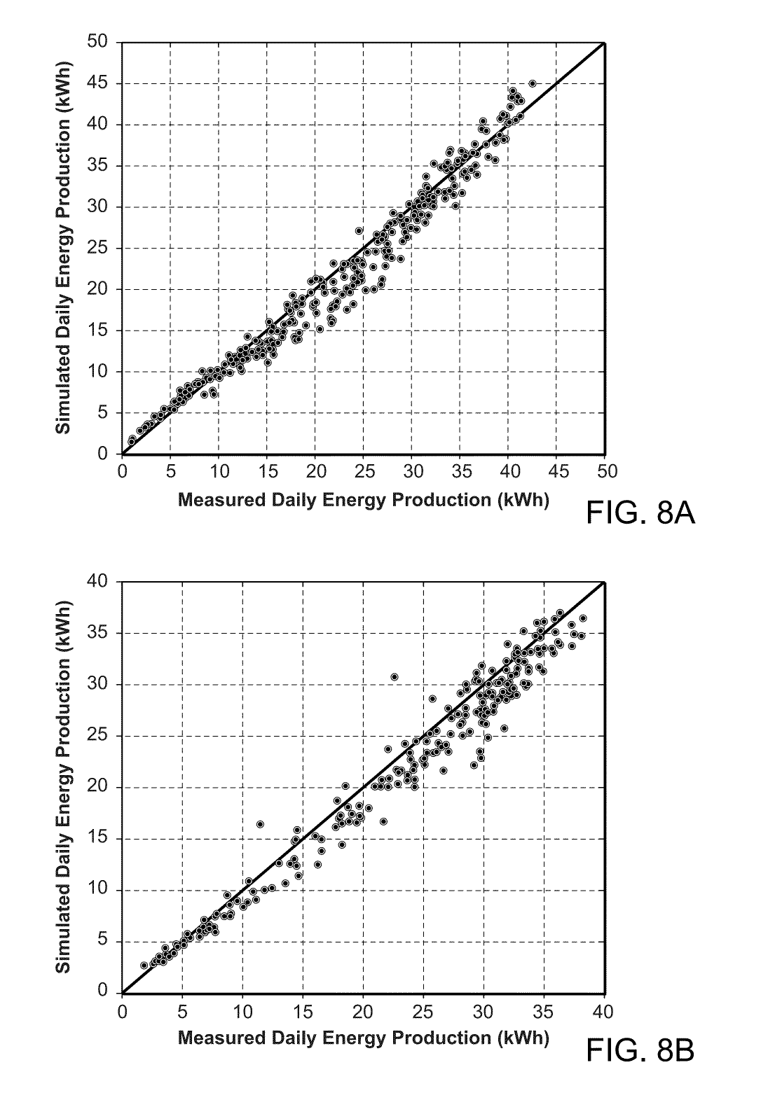

Cumulative daily energy production information was available for each system. FIGS. 8A-8B contains daily information from the second half of 2011 and the first half of 2012; therefore, it constitutes an entire year of analysis. Days where measured weather data was not available or there were errors in the measured PV yield datasets were removed from this analysis. The plots of FIGS. 8A and 8B show measured energy production on the horizontal axis and predictions of energy production on the vertical axis. The identity lines on each illustrate an ideal data distribution where prediction matches reality perfectly. From FIG. 8A, it can be seen that for all simulated days the agreement between simulations and reality is quite good for the student center PV system with a RMSE of 2.02 kWh which is 9.3% of the daily average of 21.72 kWh. Agreement between simulation and reality for the residential system is also excellent. The RMSE of the residential system predictions is 2.18 kWh or 9.4% of the daily average production of 23.22 kWh. Further analysis suggested that the greatest error is observed on partially overcast days as the Perez sky model is unable to resolve the position of clouds in the sky based solely on measured global horizontal irradiation.

Annually the student center simulations predicted 3.6% less energy production than was measured (6365.7 kWh measured, 6136.5 kWh simulated). The residential system predicted 5.3% less energy production than was measured (5154.6 kWh measured, 4881.3 kWh simulated). To help contextualize the meaning of these numbers, predictions were made for each system using a complete set of measured irradiation and temperature data from the same weather station for 2008, 2009, 2010 and 2011. The maximum variance in predicted production between the four years was 5.19% and 5.82% for the student center and residential PV arrays respectively. This suggests that the predicted annual error using the new method presented in this paper is less than variance which can be expected from climactic differences between years.

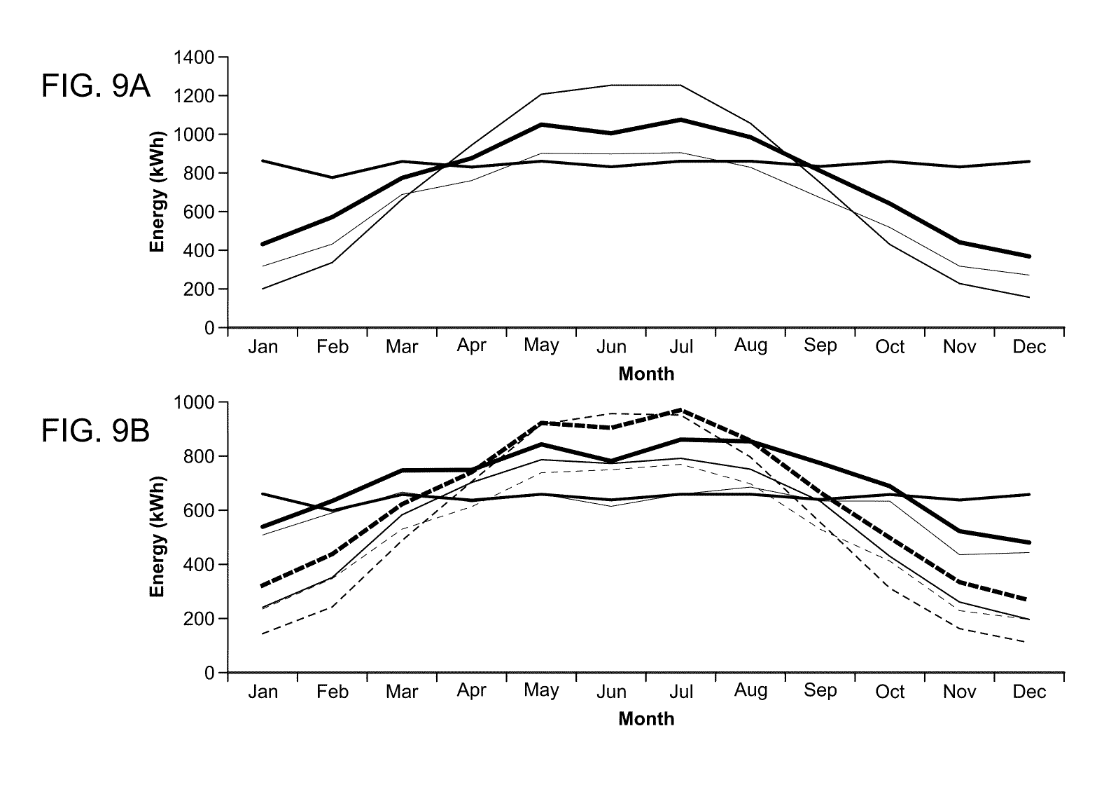

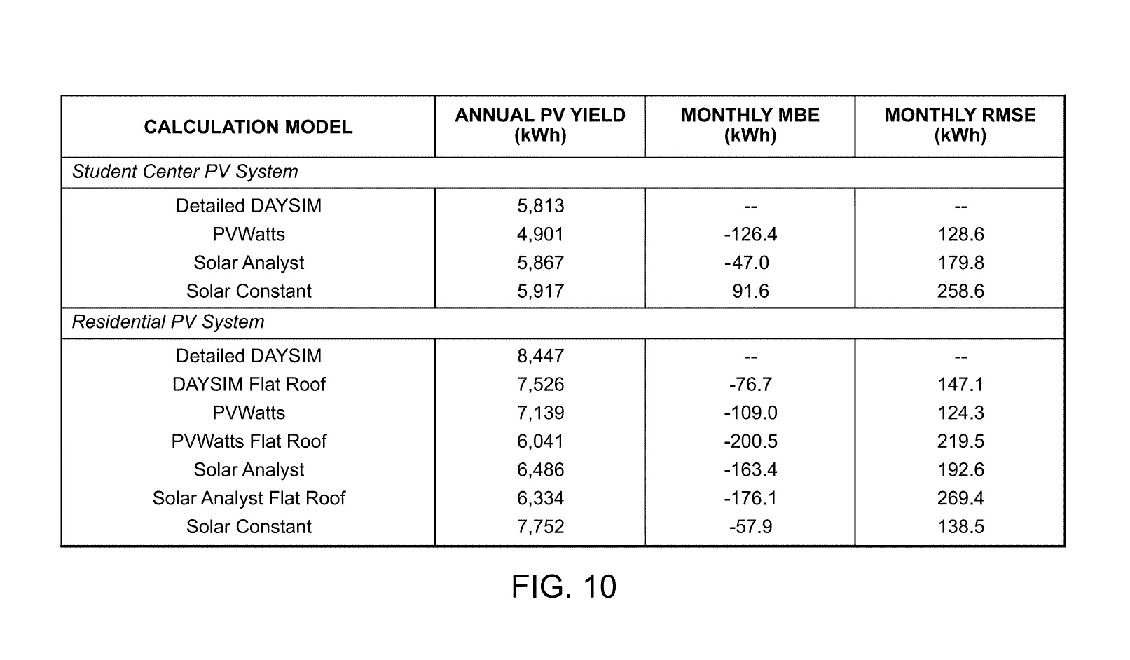

In the previous section it was demonstrated that the new method is accurate within 3.6 to 5.3 percent annually when compared to measured data while calibrating for actual weather. Since the other calculation methods cannot accommodate actual weather data as input, this section compares simulation results from the new method using Boston TMY data for the two Cambridge rooftop systems to the calculation methodologies of other existing maps namely the PVWatts, Solar Analyst and solar constant methods. In all cases, the closest possible geometric model was used. In PVWatts the exact geometric parameters of each PV array were input into the program. In Esri's Solar Analyst, a highly detailed DEM was created. Furthermore, one can assume that all methods have perfect knowledge as to the area of the PV panels; however, for the solar constant method and any which assume that a building's roof is flat, this assumption is not true. The student center PV array is nearly flat with a panel tilt of 5 degrees. On the other hand, the residential PV array is tilted at a 50 degree angle; therefore, comparisons using flat roof assumptions were added for the residential system in order to illustrate the importance of geometry in city-scale photovoltaic potential prediction. FIGS. 9A-9B shows monthly comparisons of the predicted energy yields using the various calculation methodologies described previously. FIG. 9A shows results for the student center PV system, and FIG. 9B shows results for the residential PV system. FIG. 10 presents annual PV electrical yields, monthly mean bias error (MBE) and monthly RMSE for each system compared to the new DAYSIM-based method.

For both systems, PVWatts under-predicts annual production compared to the DAYSIM-based method with MBEs of −126.4 and −109.0 kWh respectively. This is due to a default scaling factor in the PVWatts algorithm of 0.77 to account for the inverter and wiring which is likely too high. Yet, at the same time PVWatts does the best job of matching the monthly generation with a RMSE ranging between 128.6 and 124.3 kWh. This suggests that PVWatts does have the ability to predict PV electrical yields with a high degree of accuracy; however, its default scaling factor may be too high. As explored earlier, it also does not have the capacity to account for urban surroundings. For the nearly flat student center PV system, the Solar Analyst method over-predicts energy generation during the summer and under-predicts it during the winter (FIG. 9A) and has a MBE of −47.0 kWh. For the peaked roof of the residential PV system, the Solar Analyst method predicts substantially less energy generation for the entire year (FIG. 9B), and its MBE is −163.4 kWh. The solar constant method's energy production is spread evenly throughout the year, and it has no temporal variation. Therefore it has a rather large RMSE of 258.6 and 138.5 kWh for each system respectively. Overall, methods employing a flat roof assumption perform worse than those which account for the geometry and slope of the roof.

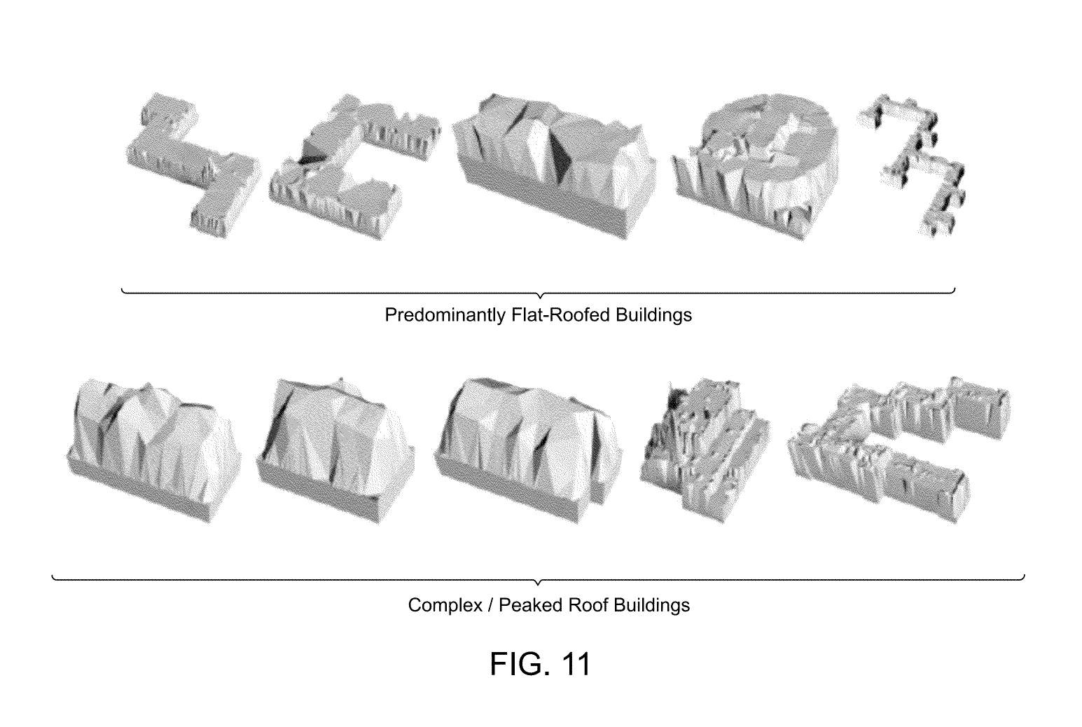

As discussed before, the different irradiation prediction methods for two Cambridge rooftop systems were compared. In order to provide a more comprehensive feeling as what these differences mean for a city-wide solar map, the analysis is expanded to ten randomly selected buildings from Cambridge which represent the overall building stock of Cambridge. Of these ten buildings, five can be described as having flat roofs; however, they often have HVAC equipment and other obstructions present on the roof such that they are not truly flat. The other five have roofs of some complexity with at least one ridge line. These test buildings are shown in FIG. 11. The authors' new DAYSIM-based method is compared to the existing Solar Analyst, flat roof and constant value methods. The flat roof calculations use the new DAYSIM-based method but with perfectly flat roofs which do not accurately represent the actual rooftop geometry. PVWatts is not included in this section as it is not easily automatable as it is a web-service relying upon manual user input. Because the Solar Analyst and constant value methods cannot account for rooftop temperatures, a constant 18.5% panel efficiency is assumed for all energy yield calculations made with those methods in this section.

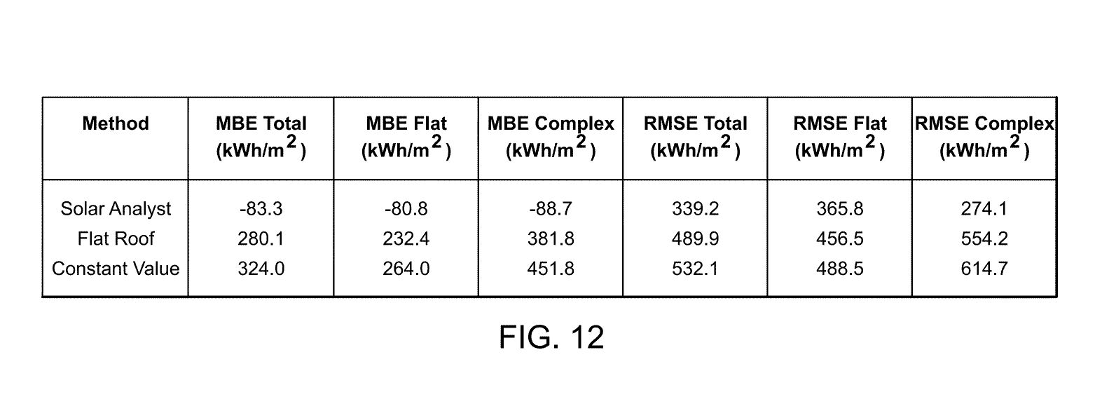

FIG. 12 shows the MBE and RMSE of existing method's annual irradiation predictions compared to the new DAYSIM-based model which the authors considered to be best-practice based on the validation and comparison studies of the previous sections. It can be seen that consideration of detailed roof geometry is important to calculation accuracy as Solar Analyst has the smallest RMSE for buildings with complex roofs at an error of 274.1 kWh/m². As expected, the flat roof method—even with detailed consideration of climate—performs poorly with an overall RMSE of 489.9 kWh/m².

Using the constant value assumption, for every point the mean global horizontal irradiation from the TMY3 data is assumed. In this case the RMSE is 532.1 kWh/m² compared to the climate-based model with detailed roof forms. The large error demonstrates that a constant assumed value is the worst performing method of solar irradiation calculations. It does not consider climate-specific data, roof shape, inter-building shading nor reflections from neighboring buildings. In terms of bias, overall Solar Analyst under-predicts irradiation while methods employing the flat roof and constant value assumptions both predict excess irradiation.

It is expected that a raytracing simulation will on average predict higher values as reflections from the ground, trees and adjacent buildings are being considered where Solar Analyst assumes such effects to be zero. However, the large error of the data suggests some other effect is at work, and this can be explained by the geometric quality of the simulation models at building edges.

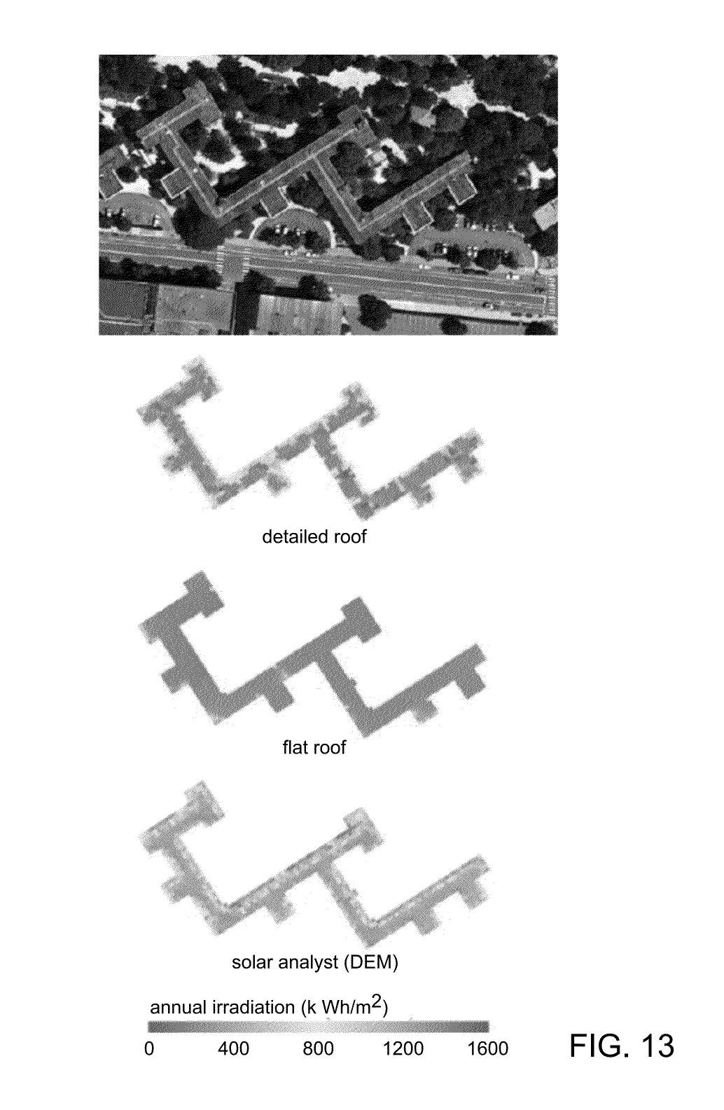

FIG. 8 shows aerial photographs and planar projections of the predicted irradiation for a single building using different methods which is typical across the ten test buildings. In the process of creating a 3-D model of a city one can use building polyline information from GIS databases to create extra points which improve the model resolution at the edge of buildings. As Solar Analyst works across a pure DEM which does not differentiate between building and ground, the calculated slope at edge pixels is extreme and can lead to stratified errors as seen in the upper edge pixels in FIG. 13. Such errors will increase as the ratio of building perimeter to plan area increases.

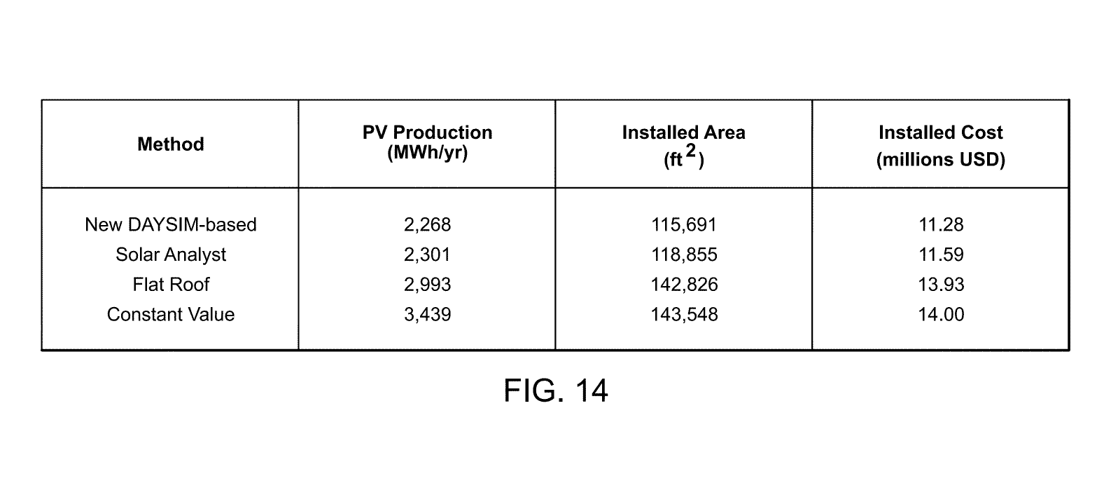

It is useful to further qualify this data into PV electrical yields. A simplified equation of annual irradiation multiplied by panel efficiency (18.5%) and area is used to calculate the the potential electrical yield when hourly data is not available. Using the new method, 2,268 MWh/yr was predicted across all rooftops with a combined 115,691 ft2 (10,748 m²) of useful roof area. Comparatively, the Solar Analyst method predicted 2,301 MWh/yr across 118,855 ft² (11,042 m²) of useful roof area. Methods which cannot represent geometry (flat roof, constant value) predict that nearly all of the flattened rooftop area is acceptable for PV installation and have similar increases in predicted installation cost. This is documented in FIG. 14 that displays total PV production which is determined to be economically useful, the related installation area and predicted installation costs.

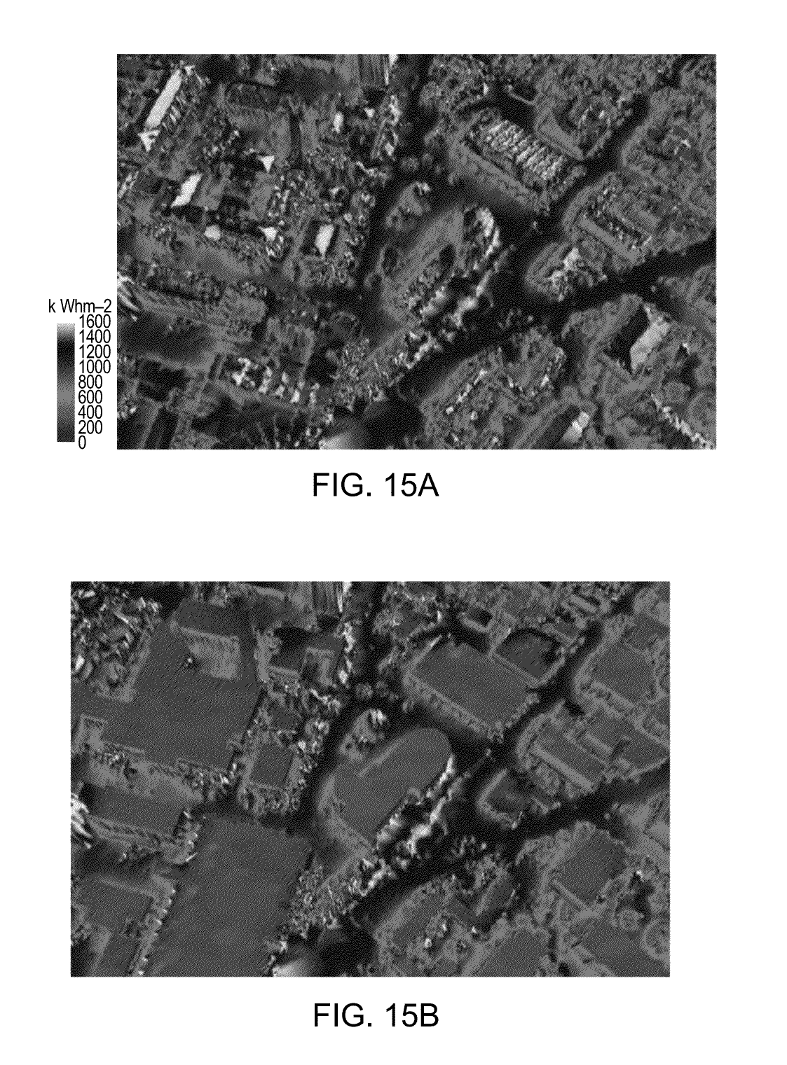

To visually underscore the importance of rooftop geometric accuracy, FIGS. 15A-15B shows an irradiation map of an urban area with detailed roofs (FIG. 15A) and with assumed flat roofs (FIG. 15B); each image displays detailed irradiation calculations of the area using the cumulative sky method. From this image alone, it is clearly visible that a flat roof assumption is going to create extreme differences in the results. This is because roof slope will change the incident angle of radiation as well as the percent and portion of visible sky. Overall, the flat roof assumption overestimates available radiation as there are no roof surfaces that slope to the north, nor are there any surfaces that face surrounding buildings; all surfaces look straight up towards the open sky above the building. Further, it is impossible for HVAC equipment or roof projections to shade another portion of the roof. The effects of roof orientation in the ten test cases are higher than the effects of inter-building shading for a city of predominantly low-rise buildings such as Cambridge.

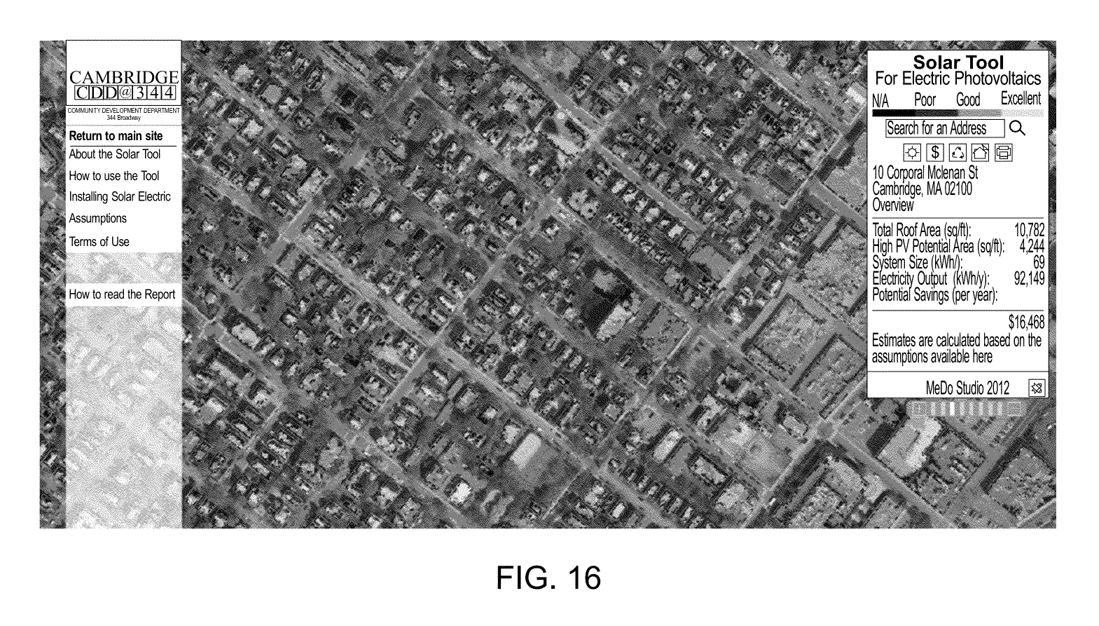

The new climate-based method of calculating photovoltaic potential constitutes the first time that city-level GIS datasets and geometric LiDAR information have been linked to a state of the art, validated daylight simulation tool. Such approaches offer exciting opportunities which point towards a new generation of sustainable urban analysis where detailed GIS databases are translated into equally detailed environmental analyses. The results from such analyses can then be fed directly back into the GIS models or a display framework to serve as design feedback for policy and decision makers as well as property owners. As a further proof of concept, the authors partnered with Modern Development Studio, a Boston based architecture and design firm and the City of Cambridge to display results on top of a searchable map document using the Google Maps API, a screenshot of which is shown in FIG. 16.

The map displays the calculated information intuitively to building owners spatially across their rooftop and fiscally in terms of economic impacts, NPV and payback periods. In this way, homeowners and businesses can engage with the map through the ability to identify their roof specifically and notice how its unique form produces varied suitability for photovoltaic installations. Essentially, users of the map feel like the simulation results are personalized to their building which is important to produce confidence in the results and to increase interest in the goals of the map.

To communicate photovoltaic potential effectively, it is necessary to provide useful visual output that aids in the understanding of the data. The authors accordingly divided the simulated rooftop solar potential for Cambridge into four bins meant to rank the relative predicted performance of a PV panel installed at that point. The thresholds are based on the previously calculated 11.25 kWh/ft² (121 kWh/m²) energy yield for a ten year NPV payback and were calculated such that 15% of the roof area of the city is considered to be “Excellent”. The four bins are as follows:
N/A<11.25 kWh/ft²-yr (121 kWh/m²-yr)
Poor 11.25-15.3 kWh/ft²-yr (121.0-165.0 kWh/m²-yr) potential energy
Good 15.3-20.4 kWh/ft²-yr (165.0-219.0 kWh/m²-yr) potential energy
Excellent>20.4 kWh/ft²-yr (219.0 kWh/m²-yr) potential energy

Admittedly, the detailed climate-based method takes more time and processing power to achieve when compared to generating a model using the flat roof assumption or using Solar Analyst combined with a detailed DEM. Each building in the city took approximately three hours of simulation time using one comprehensive model of Cambridge. This model was approximately seven square miles and contained 16,547,790 triangular surfaces. Later studies tested tiling the model in one kilometer grid cells. With this reduced model size of approximately one million triangular surfaces, buildings took ten minutes on average to simulate. The simulations can also be run in parallel to increase calculation speed. The solar constant method is instantaneous and Esri's Solar Analyst tool is also substantially faster; therefore the reader should ask, what benefits can be expected from using this new method? The previously demonstrated increase in predictive accuracy is only part of the answer to this query.

In the authors' opinion there is equally increased value in having a full 3-D model of a city. Such a model provides opportunities to investigate wall mounted PV, and subsets of the model can easily be extracted to support further analysis by design teams or government entities which make policy. FIGS. 15A-15B illustrate the utility of this model in analyzing the solar potential of building walls. It can be seen that the wall irradiation of most buildings in the area is less than rooftop insolation; however, in many locations walls can support PV with predicted annual irradiation greater than 654 kWh/m², which assuming a simple efficiency of 18.5% will generate 121 kWh/m² of energy per year. Secondly, using the validated DAYSIM software provides additional confidence in the simulation results, considers typical climate-based weather information and radiative reflections. Using DAYSIM also provides access to hourly calculated irradiation data which facilitates the use of detailed equations of PV yield that consider hourly temperatures. Such hourly data can be used in policy analysis applications to help offset the peak loads of specific cities, areas or building types. Finally, detailed rooftop area information is available for quantifying useful rooftop area and the total incident irradiation (kWh) used in the energy generation equations.

Beyond what was discussed previously, the new method has several limitations. Currently all PV panels are modeled as parallel with the roof; however, it was found that flat roofed buildings often have PV panels installed at a 45 degree tilt towards the South using standardized angle brackets. Future solar maps should therefore consider an additional layer atop flat-roofed buildings analyzing potential photovoltaic installations tilted towards the South in this manner. Further, while the method produces reasonably accurate roof forms, it should be noted that LiDAR data and the point-simplifying method introduce errors in some buildings. These errors can be expected to disappear as finer LiDAR data becomes available.

Using a detailed DAYSIM reverse raytracing simulation at the scale of the city is feasible and produces reliable results. Comparing different irradiation calculation methods on 10 different buildings, the new DAYSIM-based method predicted greater levels of irradiation annually when compared to existing urban irradiation methods using detailed roof geometry as it employs detailed sky models based on measured climate data and considers reflections from the urban surroundings. The capability of DAYSIM to accurately predict urban irradiation and the presented method to transform that irradiation into accurate PV energy yields is confirmed by a good agreement between simulated and measured energy production at two PV installations in Cambridge where annual errors ranged from 3.6-5.3%. This error range was found to be smaller than variations in predicted electricity generation between separate years.

While DAYSIM predicts greater solar irradiation than the other methods, energy production predicted using the new method is often less than currently available maps would calculate for equivalent theoretical PV systems due to the urban rooftop temperature-based efficiency model. A validation study of a system located on the MIT student center building comparing panels nearly coincident with a roof surface suggests an average decrease in energy generation of 18.3% during the sunlit hours of a hot summer week through this effect

To use validated irradiation models and predictions of photovoltaic energy generation at the city-scale is a new effort. In the future such models will support policy decisions as they allow the ability to predict hourly peak-load reduction at an urban scale or among a group of buildings whereas previous methods have not had this benefit. With increased model quality and certainty about results that can be—at least partially—visually assessed, one can aim to increase user engagement with sustainable technologies.

Although the present invention has been shown and described with respect to several preferred embodiments thereof, various changes, omissions and additions to the form and detail thereof, may be made therein, without departing from the spirit and scope of the invention.

What is claimed is:

1. A photovoltaic map generator comprising;
a data generator that provides LiDAR data illustrating detailed information of a geographic area; and
a model generator that receives the LiDAR data and uniformly resamples the LiDAR data over a plan grid of specified spacing to produce simplified LiDAR data, the data points of the simplified LiDAR data are triangulated using a Delaunay algorithm to produce a highly accurate and detailed 3-D model of the geographic area.

2. The photovoltaic map generator of claim 1, wherein the model generator comprises a Radiance/DAYSIM backward-ray tracing daylight simulation engine.

3. The photovoltaic map generator of claim 1, wherein the specified spacing comprises 1 m×1 m spacing.

4. The photovoltaic map generator of claim 1, wherein the data points of the simplified LiDAR are divided into two or more categories for triangulation.

5. The photovoltaic map generator of claim 1, wherein the 3-D model is divided into 1450×1450 m quadrants for simulation.

6. The photovoltaic map generator of claim 1, wherein each of the quadrants includes a 750×750 m region of a virtual rooftop to be simulated surrounded by 350 m of context in each direction.

7. The photovoltaic map generator of claim 1, wherein the geographic area is divided into representational sections, simulation time, and memory overhead.

8. The photovoltaic map generator of claim 1, wherein the simplified LiDAR data points are divided into two categories using publicly available building polyline GIS datasets

9. The photovoltaic map generator of claim 1, wherein the model generator resamples the LiDAR data taking the maximum value of the first return data in the plan grid where multiple points exist.

10. A method for generating a photovoltaic map comprising;
providing LiDAR based data illustrating detailed information of a geographic area;
receiving the LiDAR data and uniformly resamplingthe LiDAR data over a plan grid of specified spacing to produce simplified LiDAR data using a model generator using a model generator; and
triangulating the data points of the simplified LiDAR data using a Delaunay algorithm to produce a highly accurate and detailed 3-D model of the geographic area.

11. The method of claim 10, wherein the model generator comprises a Radiance/DAYSIM backward-ray tracing daylight simulation engine.

12. The method of claim 10, wherein the specified spacing comprises 1 m×1 m spacing.

13. The method of claim 10, wherein the data points of the simplified LiDAR are divided into two or more categories for triangulation.

14. The method of claim 10, wherein the 3-D model is divided into 1450×1450 m quadrants for simulation.

15. The method of claim 10, wherein each of the quadrants includes a 750×750 m region of a virtual rooftop to be simulated surrounded by 350 m of context in each direction.

16. The method of claim 10, wherein the geographic area is divided into representational sections, simulation time, and memory overhead.

17. The method of claim 10, wherein the simplified LiDAR data points are divided into two categories using publicly available building polyline GIS datasets

18. The method of claim 10, wherein the model generator resamples the LiDAR data taking the maximum value of the first return data in the plan grid where multiple points exist.
